(19) United States
(12) Patent Application Publication
(10) Pub. No.: US 2012/0208719 A1
(43) Pub. Date: Aug. 16, 2012

(54) ASSESSING RHEUMATOID ARTHRITIS

(75) Inventors: Sherine E. Gabriel, Rochester, MN (US); Keith L. Knutson, Rochester, MN (US); Larry R. Pease, Rochester, MN (US); John M. Davis, Rochester, MN (US)

(73) Assignee: MAYO FOUNDATION FOR MEDICAL EDUCATION AND RESEARCH, Rochester, MN (US)

(21) Appl. No.: 13/502,317

(22) PCT Filed: Oct. 13, 2010
(86) PCT No.: PCT/US10/52535

§ 371 Date: Apr. 16, 2012

Related U.S. Application Data
(60) Provisional application No. 61/252,542, filed on Oct. 16, 2009.
(60) Provisional application No. 61/254,335, filed on Oct. 23, 2009.

(51) Int. Cl. C40B 30/04

(52) U.S. Cl. 506/9

(57) ABSTRACT

This document provides methods and materials related to assessing mammals (e.g., humans) with arthritis (e.g., RA). For example, methods and materials for using cytokine response profiles to assist clinicians in assessing RA disease activity, assessing the likelihood of response and outcomes of RA therapy, predicting long-term RA disease outcomes, and assessing the risk of developing heart conditions are provided. Methods and materials for using cytokine response profiles to assist clinicians in diagnosing arthritis (e.g., RA) also are provided.

### CROSS-REFERENCE TO RELATED APPLICATIONS

This application claims priority to U.S. Provisional Application Ser. No. 61/254,335, filed on Oct. 23, 2009, and U.S. Provisional Application Ser. No. 61/252,542, filed on Oct. 16, 2009.

### STATEMENT AS TO FEDERALLY SPONSORED RESEARCH

Funding for the work described herein was provided by the federal government under grant number RR046849 and RR024151 awarded by the National Center for Research Resources. The federal government has certain rights in the invention.

### BACKGROUND

1. Technical Field

This document relates to methods and materials involved in assessing arthritis (e.g., rheumatoid arthritis) outcomes. For example, this document provides methods and materials for using cytokine response profiles to assess rheumatoid arthritis outcomes.

2. Background Information

A common problem in caring for patients with rheumatoid arthritis (RA) is the inadequacy of current disease markers to individualize the assessment of prognosis. This is important because this inflammatory autoimmune disease often leads to chronic pain, impaired quality of life, disability, extra-articular complications and comorbidity, and increased mortality. Various approaches of predicting how patients will fare long-term have been evaluated over the years; while several have been found to be informative at the population level, few, if any, have proved sufficiently predictive at the level of individual patients to justify use in clinical practice.

### SUMMARY

This document provides methods and materials related to assessing mammals (e.g., humans) with arthritis (e.g., RA). For example, this document provides methods and materials for using cytokine response profiles to assist clinicians in assessing RA disease activity, assessing the likelihood of response and outcomes of RA therapy, predicting long-term RA disease outcomes, and assessing the risk of developing myocardial dysfunction (e.g., left ventricular diastolic dysfunction or heart failure).

As described herein, cells such as peripheral blood mononuclear cells (PBMCs) obtained from a mammal having arthritis can be collected and divided into multiple samples with each sample being treated with a different stimulant or collection of stimulants. Once treated, the cells can be assessed to determine the cytokine expression profile for the cells treated with that particular stimulant or collection of stimulants. The collection of cytokine response profiles can be used to assess arthritis disease activity, to assess the likelihood of response or outcome of arthritis therapy, to predict long-term arthritis disease outcomes, or to assess the risk of developing a heart condition. For example, a collection of cytokine response profiles obtained as described herein can be used to determine whether or not a mammal having arthritis has an increased risk for developing a myocardial dysfunction (e.g., left ventricular diastolic dysfunction or heart failure).

In general, one aspect of this document features a method for assessing the severity of rheumatoid arthritis in a mammal. The method comprises, or consists essentially of, (a) contacting a first sample of cells (e.g., peripheral blood cells) from the mammal with a first stimulant to obtain a treated first sample, (b) contacting a second sample of cells (e.g., peripheral blood cells) from the mammal with a second stimulant to obtain a treated second sample, (c) contacting a third sample of cells (e.g., peripheral blood cells) from the mammal with a third stimulant to obtain a treated third sample, (d) determining the amount of at least two different cytokine polypeptides present in the treated first sample, the treated second sample, and the treated third sample to obtain an expression profile, and (e) diagnosing the mammal as having severe or mild rheumatoid arthritis based on the expression profile. The mammal can be a human. The cells can be peripheral blood mononuclear cells. The first stimulant, the second stimulant, and the third stimulant can be selected from the group consisting of anti-CD3/anti-CD28 antibodies, CMV/EBV, HSP60, PHA, SEA/SEB, CpG, and PMA. The first stimulant can be a stimulant to elicit T cell responses. The second stimulant can be a stimulant to elicit adaptive and innate cytokine responses. The third stimulant can be a stimulant to elicit innate cytokine responses. The at least two different cytokine polypeptides can be selected from the group consisting of IL-1β, IL-2, IL-4, IL-5, IL-6, IL-7, IL-8 (CXCL8), IL-10, IL-12, IL-13, IL-17, IFNγ, TNF-α, MCP-1, MIP1β, G-CSF, and GM-CSF polypeptides.

In another aspect, this document features a method for determining whether or not a mammal having rheumatoid arthritis has an increased risk for developing myocardial dysfunction. The method comprises, or consists essentially of, (a) contacting a first sample of cells (e.g., peripheral blood cells) from the mammal with a first stimulant to obtain a treated first sample, (b) contacting a second sample of cells (e.g., peripheral blood cells) from the mammal with a second stimulant to obtain a treated second sample, (c) contacting a third sample of cells (e.g., peripheral blood cells) from the mammal with a third stimulant to obtain a treated third sample, (d) determining the amount of at least three different cytokine polypeptides present in the treated first sample, the treated second sample, and the treated third sample to obtain an expression profile, and (e) diagnosing the mammal as having an increased risk for developing myocardial dysfunction or as not having an increased risk for developing myocardial dysfunction based on the expression profile. The mammal can be a human. The cells can be peripheral blood mononuclear cells. The first stimulant, the second stimulant, and the third stimulant can be selected from the group consisting of anti-CD3/anti-CD28 antibodies, CMV/EBV, HSP60, PHA, SEA/SEB, CpG, and PMA. The first stimulant can be a stimulant to elicit T cell responses. The second stimulant can be a stimulant to elicit adaptive and innate cytokine responses. The third stimulant can be a stimulant to elicit innate cytokine responses. The at least three different cytokine polypeptides can be selected from the group consisting of IL-1β, IL-2, IL-4, IL-5, IL-6, IL-7, IL-8 (CXCL8), IL-10, IL-12, IL-13, IL-17, IFNγ, TNF-α, MCP-1, MIP1β, G-CSF, and GM-CSF polypeptides. The myocardial dysfunction can be heart failure. The myocardial dysfunction can be left ventricular diastolic dysfunction.

In another aspect, this document features a method for assessing the severity of rheumatoid arthritis in a mammal. The method comprises, or consists essentially of, (a) contacting a first sample of cells from the mammal with a first stimulant to obtain a treated first sample, (b) contacting a second sample of cells from the mammal with a second stimulant to obtain a treated second sample, (c) contacting a third sample of cells from the mammal with a third stimulant to obtain a treated third sample, (d) determining the amount of a first cytokine polypeptide present in the treated first sample relative to an untreated sample of cells from the mammal to obtain a first expression profile, (e) determining the amount of a second cytokine polypeptide present in the treated second sample relative to an untreated sample of cells from the mammal to obtain a second expression profile, (f) determining the amount of a third cytokine polypeptide present in the treated third sample relative to an untreated sample of cells from the mammal to obtain a third expression profile, and (g) diagnosing the mammal as having severe or mild rheumatoid arthritis based on one or more of the first, second, or third expression profiles. The first, second, and third stimulants are different. The first, second, and third cytokine polypeptides can be the same cytokine polypeptide. The first, second, and third cytokine polypeptides can be different cytokine polypeptides.

In another aspect, this document features a method for determining whether or not a mammal having rheumatoid arthritis has an increased risk for developing myocardial dysfunction. The method comprises, or consists essentially of, (a) contacting a first sample of cells from the mammal with a first stimulant to obtain a treated first sample, (b) contacting a second sample of cells from the mammal with a second stimulant to obtain a treated second sample, (c) contacting a third sample of cells from the mammal with a third stimulant to obtain a treated third sample, (d) determining the amount of a first cytokine polypeptide present in the treated first sample relative to an untreated sample of cells from the mammal to obtain a first expression profile, (e) determining the amount of a second cytokine polypeptide present in the treated second sample relative to an untreated sample of cells from the mammal to obtain a second expression profile, (f) determining the amount of a third cytokine polypeptide present in the treated third sample relative to an untreated sample of cells from the mammal to obtain a third expression profile, and (g) diagnosing the mammal as having an increased risk for developing myocardial dysfunction or as not having an increased risk for developing myocardial dysfunction based on one or more of the first, second, or third expression profiles. The first, second, and third stimulants can be different. The first, second, and third cytokine polypeptides can be the same cytokine polypeptide. The first, second, and third cytokine polypeptides can be different cytokine polypeptides.

In another aspect, this document features a method for diagnosing arthritis (e.g., rheumatoid arthritis) in a mammal. The method comprises, or consists essentially of, (a) contacting a first sample of cells (e.g., peripheral blood cells) from the mammal with a first stimulant to obtain a treated first sample, (b) contacting a second sample of cells (e.g., peripheral blood cells) from the mammal with a second stimulant to obtain a treated second sample, (c) contacting a third sample of cells (e.g., peripheral blood cells) from the mammal with a third stimulant to obtain a treated third sample, (d) determining the amount of at least two different cytokine polypeptides present in the treated first sample, the treated second sample, and the treated third sample to obtain an expression profile, and (e) diagnosing the mammal as having arthritis based on the expression profile. The mammal can be a human. The cells can be peripheral blood mononuclear cells. The first stimulant, the second stimulant, and the third stimulant can be selected from the group consisting of anti-CD3/anti-CD28 antibodies, CMV/EBV, HSP60, PHA, SEA/SEB, CpG, and PMA. The first stimulant can be a stimulant to elicit T cell responses. The second stimulant can be a stimulant to elicit adaptive and innate cytokine responses. The third stimulant can be a stimulant to elicit innate cytokine responses. The at least two different cytokine polypeptides can be selected from the group consisting of IL-1β, IL-2, IL-4, IL-5, IL-6, IL-7, IL-8 (CXCL8), IL-10, IL-12, IL-13, IL-17, IFNγ, TNF-α, MCP-1, MIP1β, G-CSF, and GM-CSF polypeptides.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1. Cytokine response profiles of PBMC discriminated patients with both early and established RA from controls. The profiles of cytokines released into the culture supernatants by patient PBMC in response to stimulation under three separate conditions were measured using multiplexed immunoassays. The values represent the fold-changes in the geometric means (circles) and associated 95% confidence intervals (bars) among the 25 patients with early RA (A) or 60 with established RA (B) as compared to 15 controls (horizontal dotted lines). For these plots, cytokines that showed statistically significant differences at α=0.05 between RA patients and controls were included. The observed differences were tested for statistical significance using mixed effects models, adjusting for patient age, sex, and cytokine plate. The horizontal dotted line is the reference (controls).

FIG. 2. The unstimulated cytokine profiles of PBMC were less effective in discriminating patients with early or established RA from controls as compared to the stimulated profiles. The profiles of nine cytokines released by patient PBMC in cell culture without the use of any stimulant were assessed. The values represent the fold-changes in the geometric means (circles) and associated 95% confidence intervals (bars) among the 25 patients with early RA (A) or 60 with established RA (B) as compared to 15 controls (horizontal dotted lines). Differences in the values were tested for statistical significance at the level α=0.05 using mixed effects models, adjusting for patient age, sex, and cytokine plate. The horizontal dotted line is the reference (controls).

FIG. 3. Serum profiles demonstrated increased cytokine levels in the early disease patients but failed to discriminate the patients with established RA from controls. The serum profiles of the same nine cytokines and chemokines that were evaluated in PBMC culture experiments between the groups were assessed. The values represent the fold-changes in the geometric means (circles) and associated 95% confidence intervals (bars) among the 25 patients with early RA (A) or 60 with established RA (B) as compared to 15 controls (horizontal dotted lines). The serum profiles were characterized by high variability demonstrated by the wide 95% confidence limits. Multiple cytokines discriminated the patients with early RA from controls; however, there were no significant differences between the patients with established RA as compared to controls. Statistical significance (α=0.05) of the fold changes was tested using mixed effects models with adjustment for patient age, sex, and cytokine plate. The horizontal dotted line is the reference (controls).

FIG. 4. The distributions of leukocyte types in the peripheral blood did not explain the variation in the cytokine response profiles observed in the RA patients. Differential leukocyte counts, which were measured within 14 days of the PBMC sampling for cytokine response profiles, were compared between 17 patients with early RA and 16 with established RA. The distributions of total leukocyte, lymphocyte, monocyte, eosinophil, and basophil counts (X 10⁹/L) are shown on the logarithmic scale as box plots, representing the medians, 25th and 75th percentiles, and the whiskers representing the minimum and maximum values. For each cell type, side-by-side box plots compare the cellular distributions between the patients with early RA (data points on the left) and those with established RA (data points on the right). The vertical lines represent the laboratory normal ranges. Differences between the groups were assessed for statistical significance using the Wilcoxon rank sum test with α=0.05. As shown, the total leukocyte and basophil counts were mildly increased in the patients with early as compared to established RA. Additionally, there were non-significant trends toward increased lymphocytes and monocytes in early RA. While the observed differences were statistically significant, they were not clinically meaningful and do not account for the previously shown differences in the cytokine response profiles between the groups.

FIG. 5 is a graph plotting the association of the indicated cytokine for the indicated stimulant with the presence of left ventricular diastolic function in patients with RA.

FIG. 6 is a graph plotting the association of the indicated cytokine for the indicated stimulant for cells from RA patients with normal left ventricular function, patients with mild left ventricular diastolic dysfunction, and patients with moderate to severe left ventricular diastolic dysfunction or congestive heart failure.

FIG. 7. Multivariate analysis revealed a multi-cytokine immune response score. A cutoff of ≧50 easily distinguished the patients with early, highly active RA from controls. The scores among the patients with late RA showed that a subgroup had profiles of immune response that were similar to the early RA group whereas another subgroup had profiles that were similar to controls.

FIG. 8. Profiles of ex vivo cytokine production correlate with clinical disease activity in patients with early RA. The release of 17 cytokines from peripheral blood mononuclear cells into culture supernatants in response to stimulation (or in media alone) was measured by multiplexed cytokine immunoassays. The panels display the results for cytokines with differences (p<0.1) between patients with high as compared to low disease activity, defined by the composite patient-reported outcome dichotomized at the median. The stimulation conditions were (A) mixed cytomegalovirus and Epstein-Barr virus lysates (CMV/EBV); (B) eukaryotic CpG oligonucleotides (CpG); (C) phorbol myristate acetate (PMA) with ionomycina; (D) anti-CD3 and anti-CD28 T cell expander beads (CD3/CD28); (E) staphylococcal enterotoxins A and B (SEA/SEB); (F) phytohemagglutinin (PHA); (G) human heat shock protein 60 (HSP60); and (H) media alone.

FIG. 9. Relative influence of cytokines and stimulants in the model to predict the composite PRO. Gradient boosting regression tree analysis was used to predict the composite PRO with the 136 stimulated cytokine concentrations among patients with early RA (n=136 visits). The relative influence, taken as the percentage of the variance (R²) explained, for each the (A) individual cytokines and (B) stimulants in the model is shown.

### DETAILED DESCRIPTION

This document provides methods and materials related to assessing mammals (e.g., humans) with arthritis (e.g., RA). For example, this document provides methods and materials for using cytokine response profiles to assist clinicians in assessing RA disease activity, assessing the likelihood of response and outcomes of RA therapy, predicting long-term RA disease outcomes, and assessing the risk of developing heart conditions. For example, the methods and materials provided herein can be used for arthritis disease state monitoring. In some cases, the methods and material provided herein can be used to diagnose arthritis (e.g., RA).

As described herein, cells such as peripheral blood mononuclear cells (PBMCs) obtained from a mammal having arthritis can be collected and divided into multiple samples (e.g., two, three, four, five, six, seven, eight, nine, ten, or more samples). For example, a blood sample (e.g. a venous blood sample) can be obtained from a mammal (e.g., human) diagnosed with arthritis (e.g., RA) and maintained at room temperature. Within 3-4 hours (e.g., within 1-2 hours), fresh PBMCs can be isolated using, for example, a Ficoll-Hypaque gradient. Between about 1×10³ and 1×10⁶ of the isolated cells (e.g., 4×10⁴ cells) can be placed into multiple separate containers (e.g., multiple separate wells of a microtiter plate) and treated with a different stimulant or collection of stimulants. The stimulants can be designed to elicit innate cytokine responses (i.e., of monocytes), adaptive cytokine responses (i.e., of T cells), or a combination of these. Examples of stimulants include, without limitation, anti-CD3/anti-CD28 antibodies (anti-CD3/anti-CD28 antibodies), cytomegalovirus (CMV)/Epstein Barr virus (EBV), heat shock proteins (e.g., HSP60), phytohemagglutinin, staphylococcal enterotoxins A and B (SEA/SEB), CpG oligonucleotides, lipopolysaccharide (LPS), phorbol myristate acetate (PMA) and ionomycin, fibronectin, hyaluronate, and high mobility group box protein 1 (HMGB1). Once treated with a single stimulant or multiple stimulants, the cells can be assessed to determine cytokine expression profiles. Examples of cytokines for which expression thereof can be assessed include, without limitation, IL-1β, IL-2, IL-4, IL-5, IL-6, IL-7, IL-8, IL-10, IL-12, IL-13, IL-17, IFNγ, TNF-α, MCP-1, MIP1β, G-CSF, and GM-CSF polypeptides. The expression of any number of cytokines can be assessed. For example, two, three, four, five, six, seven, eight, nine, ten, eleven, twelve, 13, 14, 15, 16, 17, or more cytokine polypeptides can be assessed to determine the level of expression (e.g., the fold change in expression following stimulant treatment) by cells following treatment with a single stimulant or collection of stimulants. In some cases, a panel of nine cytokine polypeptides (e.g., IL-12, MIP-1β, TNF-α, IL-10, IL-8, IL-6, IL-17, GM-CSF, and MCP-1) can be used to obtain cytokine expression profiles. In some cases, the expression of IL-12, MIP-1β, TNF-α, and IL-10 polypeptides following treatment with anti-CD3/anti-CD28 monoclonal antibodies, of IL-8 and IL-6 polypeptides following treatment with CMV/EBV, and of IL-17, GM-CSF, and MCP-1 polypeptides following treatment with HSP60 can be used to provide a collection of cytokine response profiles that can assist clinicians in assessing arthritis disease activity, assess the likelihood of response and outcomes of arthritis therapy, predict long-term arthritis disease outcomes, and assess the risk of developing myocardial dysfunction (e.g., left ventricular diastolic dysfunction or heart failure).

The invention will be further described in the following examples, which do not limit the scope of the invention described in the claims.

### EXAMPLES

### Example 1

### Cytokine Response Profiling in Rheumatoid Arthritis: a Correlative Study of Patients with Early or Late Disease Compared to Healthy Volunteers

### Study Design and Participants

Patients with RA as defined according to the American College of Rheumatology (ACR) classification criteria were included from two ongoing cross-sectional studies. All participants were recruited in parallel. First, patients with recently diagnosed disease (early RA) were recruited from the outpatient clinic. Second, patients with established RA, who had been recruited from the community of Olmsted County, Minn. to study the relationships between cytokine response profiles and cardiovascular disease, were included. Healthy volunteers with no history of inflammatory or autoimmune diseases were recruited by advertisement from campus bulletin boards. The procedures for blood sampling and transport were similar for all subjects. Exclusion criteria included any history of other autoimmune connective tissue diseases (i.e., lupus), malignancy diagnosed within the past one year (with the exception of non-melanoma skin cancers), or chemotherapy within the past one year. The study was approved by the Mayo Foundation institutional review board and was conducted according to the principles of the Declaration of Helsinki All patients provided written informed consent prior to participation.

### PBMC Isolation, Cell Culture, and Stimulation Panel

A single, experienced laboratory technician performed all experiments, which had identical procedures for all subjects. Venous blood samples were harvested and maintained at room temperature. Within 1-2 hours, fresh PBMC were isolated by Ficoll-Hypaque gradients. The PBMC were stimulated in tissue culture under 8 separate conditions using a panel of stimuli. Monoclonal antibodies to the CD3 receptor and the costimulatory molecule CD28 (anti-CD3/anti-CD28 antibodies) (Dynabeads® Human T-Activator, Invitrogen, Carlsbad, Calif.) as well as a plant lectin, phytohemagglutinin (PHA) (Sigma, St. Louis, Mo.), were used to crosslink signaling receptors and thereby activate T cells under conditions not requiring antigen presentation. Staphylococcus enterotoxins A and B (SEA/SEB) (Toxin Technology, Sarasota, Fla.) are bacterial superantigens capable of cross-linking MHC class I and class II molecules on antigen presenting cells to T cell receptors, activating naïve and memory T cells independently of antigen (Cameron et al., Eur. Cytokine Netw., 12(2):210-22 (2001)). Combined cytomegalovirus and Epstein Barr virus lysates (CMV/EBV) (Advanced Biotechnologies, Columbia, Md.) were selected to induce T cell responses in an antigen-dependent manner with strong Th1 (cell-mediated) and considerably milder Th2 (humoral) responses (Sinclair et al., Viral Immunology, 17:445-54 (2004) and Wang et al., Transplantation Proceedings, 36(5):1498-9 (2004)).

Three molecules containing pathogen-associated molecular patterns were selected to induce innate cytokine responses via Toll-like receptor (TLR) signaling pathways. CMV/EBV lysates contain ligands for TLR2, TLR3, and TLR9 (Compton et al., J. Virol., 77(8):4588-96 (2003) and Tabeta et al., Proc. Natl. Acad. Sci. USA, 101(10):3516-21 (2004)), and bacterial CpG oligonucleotides (CpG) are ligands for TLR9 (Rutz et al., Eur. J. Immunol., 34(9):2541-50 (2004)); these molecules activate cytokine production in B cells and innate immune effectors (i.e., monocytes, dendritic cells). Human heat shock protein 60 (HSP60) (Stressgen, Victoria BC, Canada) is an endogenous ligand for TLR2 and TLR4 that is released by damaged tissues into the extracellular microenvironment (Calderwood et al., FEBS Lett., 581(19):3689-94 (2007); Cohen-Sfady et al., J. Immunol., 175(6):3594-602 (2005); and Vabulas et al., J. Biol. Chem., 276(33):31332-9 (2001)). HSP60 modulates innate and adaptive immunity through both proinflammatory and anti-inflammatory (i.e., regulatory T cell) responses. Subsets of patients with RA have antigen-specific T cell or autoantibody-mediated responses to this molecule. Finally, phorbol myristate acetate with ionomycin [PMA/ION] (Sigma, St. Louis, Mo.) was included as a stimulus to activate diverse cell types via induction of protein kinases in mitogenic pathways. For comparison, we evaluated the release of cytokines by unstimulated PBMC into the culture supernatants.

For each stimulation condition, 4×10⁵ PBMC were cultured in 200 μL of medium (RPMI-1640+10% FBS+1% PSG) containing a stimulant in quadruplicate wells of a micro-titer plate. The final concentrations of each stimulant in cell culture were as follows: anti-CD3/anti-CD28 antibodies, 0.5×10⁶ beads per culture well (1:1 ratio of beads to PBMC per manufacturer instructions); PHA, 5 μg/mL; SEA/SEB, 10 ng/mL for both SEA and SEB; CMV/EBV, 1 μg/mL; CpG, 10 μg/mL; HSP60, 1 μg/mL; and PMA/ION, 1 μg/mL PMA and 700 ng/mL ION. The PBMC were incubated at 37° C. in 5% CO₂ for 48 hours; the supernatants were subsequently harvested, transferred to a storage plate, and frozen at −80° C. for later analysis.

### Leukocyte Differentials

The results of complete blood counts (CBC) and differentials were collected from electronic laboratory records where available. These results were included if the CBC had been drawn within 14 days of the blood sampling for cytokine profiling. Data were available for a sample of the RA patients but none of the controls.

### Multiplexed Cytokine Immunoassays

A panel of 17 cytokines was analyzed using a multiplexed approach with commercially available human 17-plex kits. The following cytokines were assessed: IL-1β, IL-2, IL-4, IL-5, IL-6, IL-7, IL-8 (CXCL8), IL-10, IL-12, IL-13, IL-17, IFNγ, TNF-α, MCP-1 (CCL2), MIP1β (CCL4), G-CSF, and GM-CSF. For serum samples, we used the Bio-Plex 17-plex kit (Bio-Rad Laboratories, Hercules, Calif.) and determined the cytokine concentrations using Bio-Plex 200 reader (Bio-Rad Laboratories). For the stimulated PBMC culture supernatants, we used a customized platform obtained from Meso Scale Discovery (MSD, Gaithersburg, Md.) and determined the cytokine concentrations using the MSD Sector 2400 instrument. This technology was chosen because the MSD platform performed better than the Bio-Plex at values near the upper limit of detection (data not shown). Cytokine concentrations were determined based on a standard curve generated on each plate using the manufacturer-supplied reagents.

### Statistical Analysis

The distributions of the patient characteristics were described using the mean±standard deviations (SD) for continuous variables or numbers and percentages for categorical variables. To test for differences between the groups, we used the t-test for continuous variables or the χ² test for categorical variables. To determine the relationships between cytokines, we used Spearman's correlations with the stimulated cytokine values. Differences in the peripheral blood leukocyte counts between the patients with early and established disease were tested for statistical significance using the Wilcoxon rank sum test.

In analyzing the data, the methods were required to explicitly account for the multiplicity and inter-relatedness of the stimulated cytokine values, along with the blocking induced by multiple patients and assays per reaction plate. Mixed effects models were used to estimate and test for differences between the groups. All analyses were done using log transformed cytokine concentrations, leading to geometric means and percent differences between groups. The models included fixed effects for age, sex and stimulation and random effects for subject and plate. The values as presented are therefore adjusted for age, sex, and assay effects.

### Results

### Patient Characteristics

25 patients with early RA, 60 with established RA, and 15 healthy volunteers as controls were recruited (Table 1). The patients with early RA, who were nearly a decade younger on average than the patients with established RA, were essentially newly diagnosed (mean disease duration=0.2 years) and only just beginning disease-modifying therapy. Consequently, the early patients had highly active disease as demonstrated by high values for C-reactive protein, the HAQ disability index, and visual analogue pain scores. In contrast, the patients with established RA had milder disease that was fairly quiescent on average, with low mean scores for pain and HAQ disability and normal levels of acute phase reactants. The patients with early RA had a higher frequency of anti-CCP antibodies and a similar frequency of erosive disease (as determined by radiologist reports of available x-rays) as compared to the patients with established disease.

TABLE 1
Baseline characteristics of the patients with early
or established RA as compared to controls.*

| | Controls | Early RA | Established RA | |
|---|---|---|---|---|
| Variable | (N = 15) | (N = 25) | (N = 60) | P-value |
| Age | 44.6 ± 16.8 | 50.9 ± 14.1 | 60.3 ± 9.1 | <0.001 |
| Sex, No. (%) | | | | 0.15 |
| Female | 8 (53%) | 18 (72%) | 47 (78%) | |
| Male | 7 (47%) | 7 (28%) | 13 (22%) | |
| Disease duration (yrs) | — | 0.2 ± 0.3 | 13.6 ± 5.6 | <0.001 |
| CRP (mg/L) | — | 40.3 ± 44.6 | 4.1 ± 4.7 | <0.001 |
| HAQ disability index (0-3) | — | 1.4 ± 0.7 | 0.5 ± 0.5 | <0.001 |
| HAQ pain score (0-3) | — | 1.6 ± 0.7 | 0.9 ± 0.7 | <0.001 |
| VAS pain (0-100 mm) | — | 52.4 ± 29.1 | 30.9 ± 22.9 | 0.006 |
| Anti-CCP, No. (%) | — | 18 (72%) | 26 (43%) | 0.016 |
| RF, No. (%) | — | 17 (68%) | 33 (55%) | 0.27 |
| Erosions, No. (%) | — | 6 (27%) | 25 (44%) | 0.18 |
| MTX use, No. (%) | — | 9 (36%) | 29 (48%) | 0.30 |
| Steroids use, No. (%) | — | 9 (36%) | 19 (32%) | 0.70 |
| Other DMARDs, No. (%) | — | 5 (20%) | 23 (38%) | 0.10 |
| Anti-TNF use, No. (%) | — | 0 (0%) | 14 (23%) | 0.008 |

*All values are mean ± SD except as indicated otherwise. Abbreviations: RA = rheumatoid arthritis; No. = number; HAQ = health assessment questionnaire; VAS = visual analogue scale; CCP = cyclic citrullinated peptides; RF = rheumatoid factor; DMARDs = disease modifying antirheumatic drugs; TNF = tumor necrosis factor.

### Selection of the Cytokine Response Panel

Differences in 136 values (8 stimulation conditions*17 cytokines) were tested between the groups. The analyses showed statistically significant differences for 58 of 136 (43%) of the stimulated cytokine values between the groups at the significance level of 0.05 (data not shown). The large number of statistically significant differences indicated that these profiles easily distinguish the RA patients from controls.

Preliminary analyses informed the approach of selecting the cytokine response panel. Two of the cytokines, IL-4 and IL-7, which had a large number of results that were at the lower limit of detection of the assay platform were first excluded, leaving 8*15=120 potentially significant stimulated cytokine values. In this context, possible approaches to discovery of biomarker profiles that reliably discriminate the patient groups while controlling for the likelihood of spurious findings are: limiting the investigation to results meeting a threshold for fold change (i.e., 2-fold); using more stringent cutoffs for statistical significance (i.e., <0.001); post-fitting controls such as false discovery rate; or directing the analysis towards known cellular immune mechanisms. Clear, recurring patterns of cytokine response most characteristic of either T cell responses (i.e., under stimulation with anti-CD3/anti-CD28, PHA, SEA/SEB, HSP60, or PMA/ION) or myeloid lineage responses (i.e. under stimulation with CMV/EBV, CpG, HSP60, or PMA/ION) were observed. Therefore, it was decided to select the cytokine response profile by focusing on mechanistic considerations (i.e., relevance to known mechanisms involved in RA pathogenesis or likely cellular sources), by optimizing the magnitude and statistical significance of the differences between the groups (i.e., favoring cytokines with p values of <0.001 as opposed to cytokines with p=0.04), and by excluding cytokines with little added value. Considerable redundancy was found in the profiles of several cytokines between different stimuli. For example, the responses of PBMC to anti-CD3/anti-CD28 and SEA/SEB, or CpG and HSP60, were typically similar. Ultimately, a 9-cytokine profile was selected for further analysis and data presentation, comprising three stimulation conditions: anti-CD3/anti-CD28 to elicit T cell responses, CMV/EBV to elicit adaptive and innate cytokine responses, and finally HSP60, to elicit innate cytokine responses (Table 2).

TABLE 2
Distributions of cytokine concentrations for the selected 9-cytokine response
panel among patients with early or established RA as compared to controls.*

| | | Controls | | Early RA | | Established | |
|---|---|---|---|---|---|---|---|
| Cytokine | Stimulation | (N = 15) | | (N = 25) | | (N = 60) | |
| IL-12 | anti-CD3/anti- | 22.7 | (19.0, 34.5) | 13.7 | (8.5, 22.1) | 17.2 | (11.7, 25.8) |
| | CD28 | | | | | | |
| MIP-1β | anti-CD3/anti- | 112709 | (35167, 305774) | 36696 | (19877, 67245) | 60664 | (45030, 99887) |
| | CD28 | | | | | | |
| TNF-α | anti-CD3/anti- | 6689 | (5020, 12959) | 2795 | (1045, 7219) | 4114 | (2637, 8029) |
| | CD28 | | | | | | |
| IL-10 | anti-CD3/anti- | 4114 | (1570, 9576) | 1460 | (453, 4966) | 2069 | (1007, 56028) |
| | CD28 | | | | | | |
| IL-8 | CMV/EBV | 994 | (438, 1909) | 414 | (250, 557) | 403 | (293.1, 539.6) |
| IL-6 | CMV/EBV | 35288 | (21005, 57747) | 63664 | (29634, 132442) | 70161 | (46238, 108898) |
| IL-17 | HSP60 | 5.2 | (0.3, 119.4) | 13.4 | (0.7, 82.7) | 35.7 | (26.8, 122.4) |
| GM-CSF | HSP60 | 14.0 | (4.6, 196.8) | 25.7 | (34.1, 184.1) | 82.4 | (44.6, 201.7) |
| MCP-1 | HSP60 | 6639 | (2211, 22423) | 9475 | (3257, 31247) | 12034 | (7498, 28071) |

*Values are the geometric means (25^{th} percentile, 75^{th} percentile) for the concentrations (pg/ml) of individual cytokines in the supernatants of stimulated PBMC cultures according to stimulation and group. These results were obtained by taking the means of log-transformed cytokine concentrations using normalized data from mixed effects models and then converting back to the raw scale.

Cytokine Response Profiles of Cultured PBMC in Patients with Early or Established RA as Compared to Controls

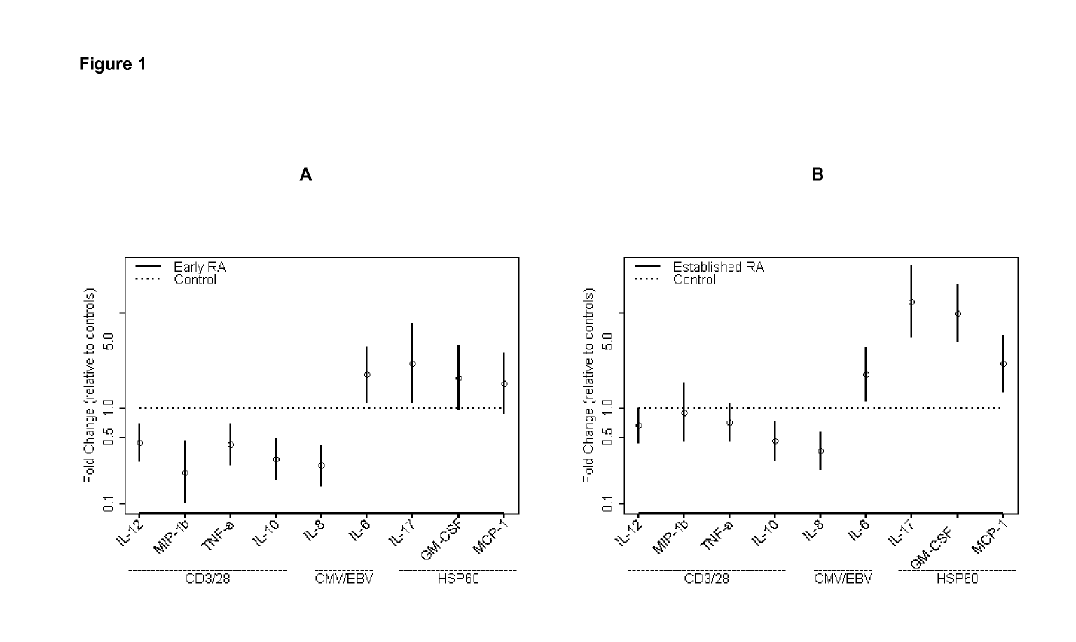

The fold changes in the 9-cytokine profiles were investigated for patients with early RA as compared to controls (FIG. 1A). In response to stimulation with anti-CD3/anti-CD28, the PBMC of patients with early RA exhibited significantly reduced production of IL-12, MIP-1β, TNF-α, and IL-10, each by more than 50%, as compared to controls. In response to CMV/EBV, the PBMC produced significantly decreased IL-8 as compared to controls. A different pattern was evident with HSP60 stimulation, in which case the PBMC of patients with early RA produced significantly elevated levels of IL-17, GM-CSF, and MCP-1 as compared to controls. CMV/EBV induced similarly increased responses of IL-6. The profiles of GM-CSF and MCP-1 production in the context of HSP60 stimulation mirrored those of IL-17. Indeed, highly statistically significant correlations were observed between IL-17 and GM-CSF (p=0.897; p<0.0001) and IL-17 and MCP-1 (p=0.790; p<0.0001).

The 9-cytokine profiles were different for the patients with established RA (FIG. 1B). By comparing the profiles of established to early RA patients, it was apparent that in the established group the impairments to anti-CD3/anti-CD28 were attenuated for IL-12, MIP-1β, and TNF-α, and partially so for IL-10. The impairments of IL-8 responses to CMV/EBV were also partially attenuated. The PBMC of the established RA patients had significantly increased release of IL-6 in response to CMV/EBV as well as IL-17, GM-CSF, and MCP-1 in response to HSP60 as compared to controls. It appeared that the cytokine responses to HSP60 (IL-17, GM-CSF, and MCP-1) were qualitatively increased in the patients with established as compared to early RA.

Unstimulated Cytokine Profiles of PBMC, or the Differences in the Profiles from the Basal State to Stimulation, in Patients with Early or Established RA as Compared to Controls

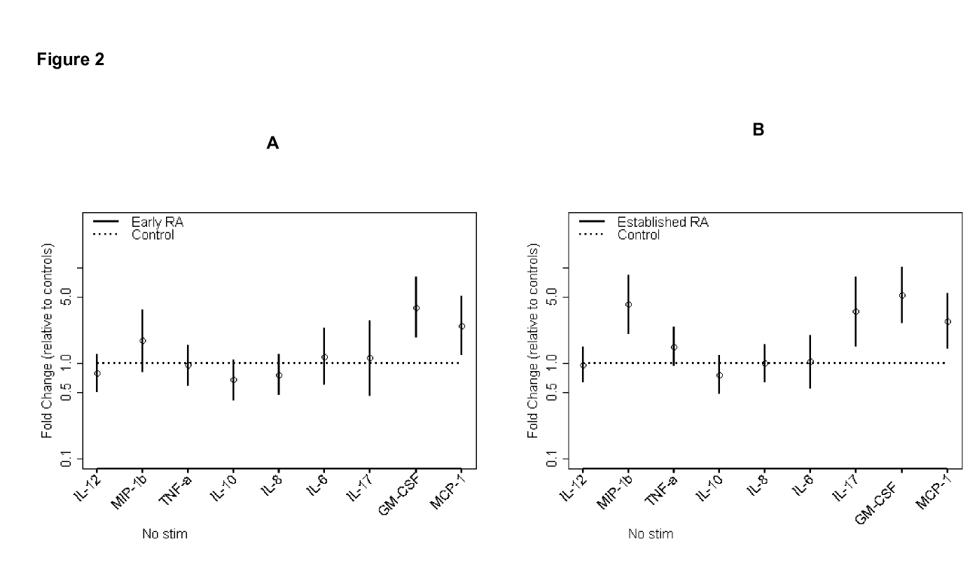

In order to evaluate the usefulness of stimulating the PBMC to induce cytokine production, the above data were compared to unstimulated cytokine profiles of PBMC in patients compared to controls (FIG. 2). Under basal conditions, the patients with early RA exhibited significantly increased production of GM-CSF and MCP-1 as compared to controls (FIG. 2A). The patients with established RA demonstrated increased responses of GM-CSF and MCP-1 and also of MIP-1β and IL-17 as compared to controls (FIG. 2B). The differences of the unstimulated profiles between the groups (particularly for early RA) were fewer in number and of lower magnitude as compared to the stimulated profiles.

The fold changes between the patient groups and controls in the differences between the stimulated and unstimulated cytokine values were also evaluated. These were no more informative than the stimulated values (as shown in FIG. 1A-B), when considered in isolation (data not shown).

Comparison with Cytokine Profiles in the Serum of Patients with Early or Late RA as Compared to Controls

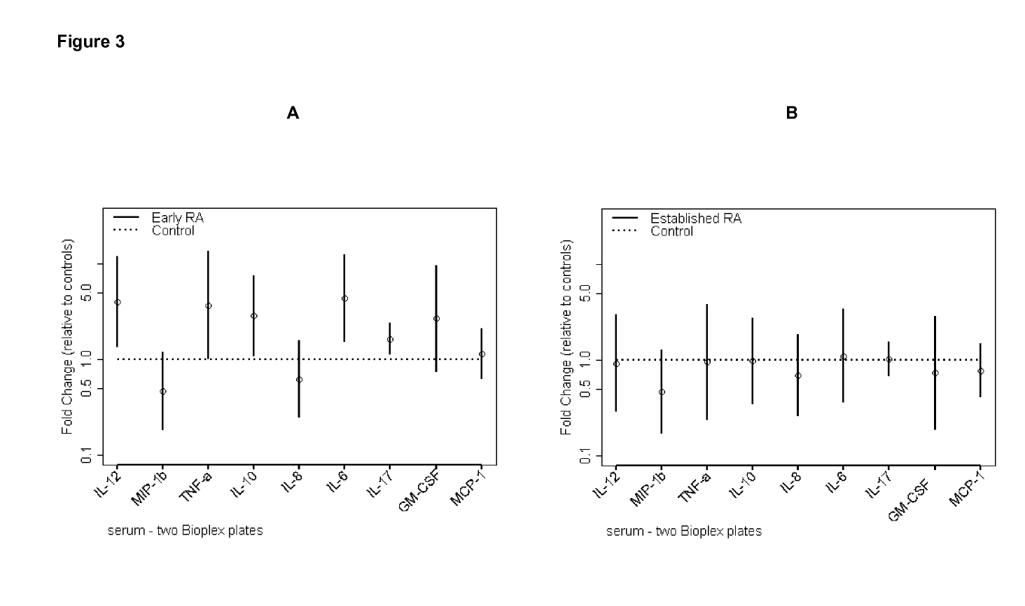

Considering that serum multi-cytokine profiles have been shown to discriminate patients with RA and controls, the profiles of the same nine cytokines and chemokines that were assessed in PBMC culture supernatants were compare for the serum samples (FIG. 3). Patients with early RA had significantly elevated levels of IL-12, TNF-α, IL-10, IL-6, and IL-17, between 2- and 5-fold in magnitude, as compared to controls (FIG. 3A). In contrast, the patients with established, long duration RA had no significant differences compared to controls (FIG. 3B).

Comparison of Peripheral Leukocyte Differentials Between the Patients with Early and Established RA

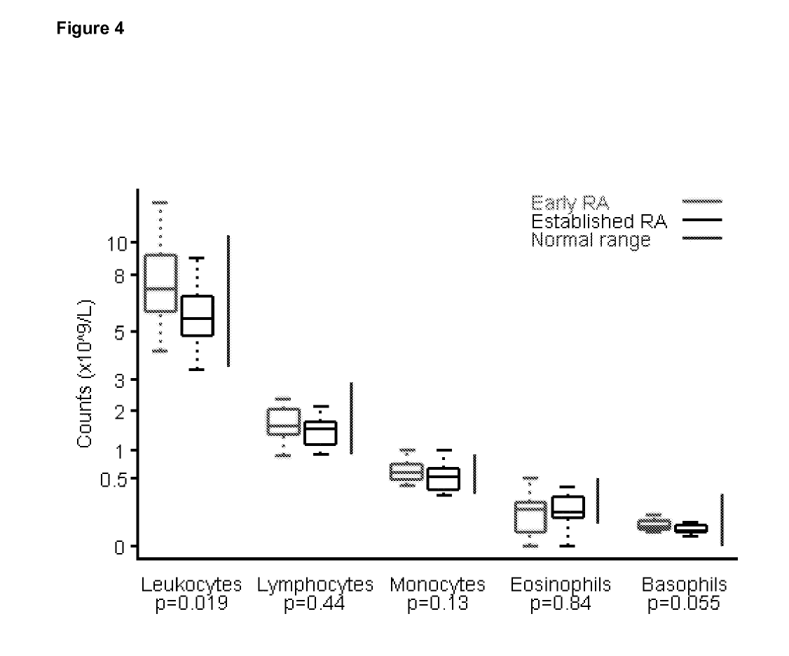

The peripheral blood leukocyte differentials were compared between the patients with early and established disease, in order to evaluate the possibility that changes in the distribution of peripheral immune cell types might explain the differences in the cytokine response profiles between the groups (FIG. 4). A small but statistically significant increase in total leukocytes in the patients with early RA was observed as compared to established RA (p=0.019). There was a non-significant trend toward mild increases in the basophils of the patients with early as compared to established disease (p=0.055). There were no significant differences in the distributions of lymphocytes (p=0.44), monocytes (p=0.13), or eosinophils (p=0.84) between the groups.

### Development of an Immune Response Score

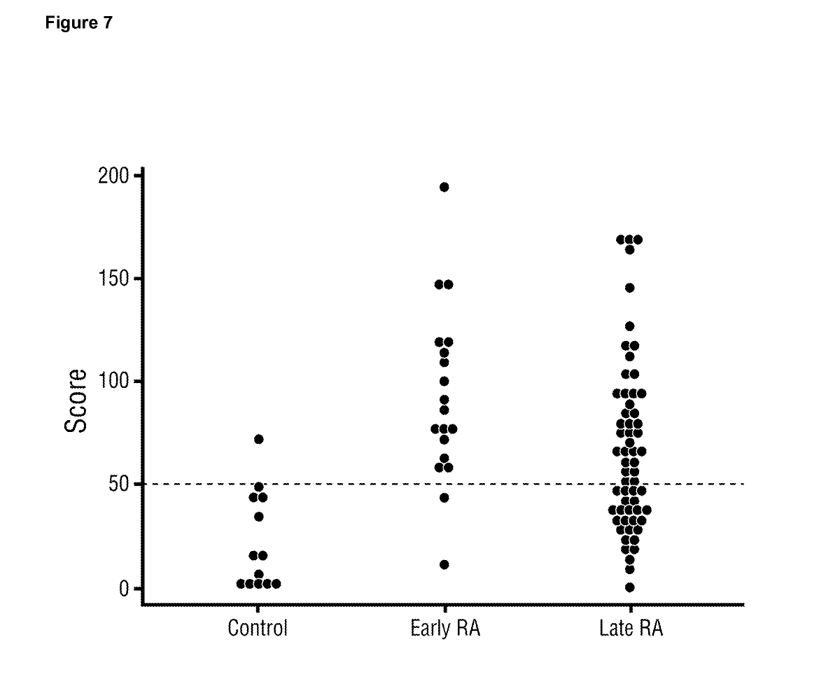

An immune response score, which integrated the variation for each individual cytokine of the selected cytokine response profile into a continuous index of immune response, was created (FIG. 7). The cutoff of >50 accurately classified 17 of 19 early RA patients and 12 of 13 controls, indicating that the immune response score performed very well in discriminating the early RA group from controls. Among the 60 patients with late RA group, 35 had an immune response score of >50 and 25 had a score of <50, showing greater heterogeneity among the late RA group, with some individuals having immune profiles more similar to early RA patients and others having profiles more similar to controls.

The construct validity of the immune response score was assessed by testing whether subgroups of the patients with late RA defined by dichotomous levels of the immune response score differed in several clinical indicators of disease severity (Table 3). The groups had similar distributions for age, sex, and disease duration. However, the group with higher immune response scores had higher levels of disability as defined using the HAQ (p=0.05) and higher proportions of rheumatoid factor (RF) (p=0.048), erosive disease (p=0.025), and methotrexate (MTX) use (p<0.001). The group with higher immune response scores tended to have higher CRP (p=0.09) and to be taking TNF blockers (p=0.08). Notably, there was no association between prednisone use and the score.

TABLE 3
A multi-cytokine immune response score among subjects with late
RA distinguishes subgroups with different disease severity.*

| | Score <50 | Score ≧50 | |
|---|---|---|---|
| Variable | (N = 25) | (N = 35) | P-value |
| Age | 58.3 ± 9.5 | 61.7 ± 8.8 | 0.16 |
| Sex, no. (%) | | | 0.12 |
| Female | 22 (88%) | 25 (71%) | |
| Male | 3 (12%) | 10 (29%) | |
| Disease duration, yrs | 13.3 ± 6.5 | 13.8 ± 4.9 | 0.76 |
| C-reactive protein, mg/L | 2.9 ± 3.6 | 5.0 ± 5.3 | 0.09 |
| Pain VAS (0-100 mm) | 26.8 ± 22.3 | 33.8 ± 23.2 | 0.26 |
| HAQ disability index >1 | 2 (8%) | 10 (29%) | 0.05 |
| ACPA positive, no. (%) | 9 (36%) | 17 (49%) | 0.33 |
| RF positive, no. (%) | 10 (40%) | 23 (66%) | 0.048 |
| Erosive disease, no. (%) | 6 (25%) | 19 (54%) | 0.025 |
| MTX use, no. (%) | 5 (20%) | 24 (69%) | <0.001 |
| Prednisone use, no. (%) | 6 (24%) | 13 (37%) | 0.28 |
| Other DMARD use, no. (%) | 8 (32%) | 15 (43%) | 0.39 |
| Anti-TNF use, no. (%) | 3 (12%) | 11 (31%) | 0.08 |

*Values are mean ± SD except as indicated otherwise. Abbreviations: RA = rheumatoid arthritis; HAQ = health assessment questionnaire; VAS = visual analogue scale; ACPA = anti-citrullinated protein antibodies; RF = rheumatoid factor; MTX = methotrexate; DMARDs = disease modifying antirheumatic drugs; TNF = tumor necrosis factor.

In a sensitivity analysis, another ex vivo cytokine profile was assembled that evaluated only those ten cytokines with the most statistically significant differences (all p<0.01) among the patient groups and controls, without considering potential mechanisms. This profile included release of IL-12, CCL4, TNF-α, IL-4, and IL-10 in response to anti-CD3/anti-CD28; CXCL8 release in response to CMV/EBV; GM-CSF production in media alone; G-CSF release in response to HSP60; and IL-7 release in response to PMA with ionomycin. The immune response score based on this profile performed as well as the former score in discriminating the early RA group from controls but correlated poorly with markers of disease severity among the late RA group (data not shown).

### Discussion

In this study, a strategy to discover biomarkers that predict response to therapy or long-term outcomes of RA by comparing cytokine response profiles between patients with early or established RA as compared to controls was developed. The following themes emerged from the results provided herein: (1) Cytokine response profiling revealed an immunologic ‘signature’ that was associated with RA and characterized by dysfunctional systemic immunity. Some immune responses were defective, particularly in early RA, yet others exaggerated, particularly in late RA. Furthermore, the developed approach distinguished early, highly active RA as well as longstanding, minimally active RA from controls, demonstrating the potential utility of this method in identifying improved biomarkers. (2) The strategy of cytokine response profiling was more informative than routinely available biomarkers as well as serum cytokine profiling by discriminating patients with early as well as late RA from controls. Based on the results provided herein, cytokine response profiling can be useful to identify patients with inadequate recovery of peripheral immune homeostasis, which could indicate deleterious immune mechanisms persisting in diseased tissues, thereby placing affected individuals at risk for bad outcomes such as progressive joint destruction, extra-articular manifestations, or comorbidities.

Cytokine Response Profiling Reveals Immunologic Signatures of Aberrant Systemic Immunity that Correlate with Disease Outcomes

The results provided herein demonstrate that patients with early RA have significant defects in the responsiveness of particular circulating T cell subsets. Impairments in the function of peripheral blood Th1 (i.e., IL-12 and TNF-α), Th2 (i.e., IL-10), and cytotoxic T cell (i.e., MIP1β) compartments most likely account for these results. T cells typically do not produce IL-12, but impaired Th1 responses could account for low production of downstream mediators such as IL-12 by myeloid cells. The results provided herein demonstrate that the impairments were far less apparent in patients with established RA, suggesting that Th1 and Th2 immunity partially recovers when the clinical disease activity is controlled.

The results provided herein demonstrate that patients with RA had significantly increased responsiveness to stimulation with TLR ligands, including increased release of IL-6 with CMV/EBV and of GM-CSF with HSP60. These findings might be explained by disease-associated changes in the myeloid compartment such as an increased frequency or function of a proinflammatory subset of monocytes.

The results provided herein suggest that the responsiveness of Th17/IL-17 regulating pathways in circulating PBMC is increased in patients with RA, higher in patients with established as compared to early active disease. The results also demonstrate that stimulation of PBMC with HSP60 (a TLR4 ligand) induced coordinated responses of IL-17, GM-CSF, and MCP-1. Significant IL-17 production with anti-CD3/anti-CD28 was not observed (data not shown), suggesting that HSP60-induced activation of myeloid cells is upstream of Th17 differentiation in this context. Regarding the data on GM-CSF, it is relevant that IL-17 signaling can lead to increased GM-CSF production, which may function to increase neutrophil survival and activity. The results provided herein contribute to the body of knowledge regarding Th17/IL-17 activity in patients with RA and highlights the importance of this pathway to human disease.

Fewer significant differences were found in the unstimulated cytokine profiles than with stimulation. Without stimulation, the impairments of Th1/Th2 responses were not observed, but the increased Th17 (i.e., IL-17A) and myeloid lineage responses (i.e., GM-CSF) under basal conditions were evident. These results were similar to the HSP60 stimulated profiles, which also showed more potent responses in late than in early disease, so similar mechanisms may underlie the unstimulated and stimulated production of these Th17 and myeloid derived cytokines. The data provided herein demonstrate the added value of assessing functional changes in the immune system globally using a panel of stimuli.

Cytokine Response Profiling is Potentially More Informative than Serum Biomarkers or Blood Leukocyte Counts

Several studies of patients with RA have reported data on serum multi-cytokine profiling that differ considerably from our results using ex vivo cytokine response profiling. For example, higher disease severity is correlated with higher levels of serum TNF-α, IFN-γ, IL-4, and IL-10 (Hueber et al., Ann. Rheum. Dis., 66(6):712-9 (2007) and Hitchon et al., J. Rheumatol., 31(12):2336-46 (2004)), whereas the production of these T cell cytokines by stimulated PBMC was significantly reduced in the study provided herein. In contrast, higher disease severity is correlated with higher levels of serum IL-6, GM-CSF and MCP-1 (Hueber et al., Ann. Rheum. Dis., 66(6):712-9 (2007) and Hitchon et al., J. Rheumatol., 31(12):2336-46 (2004)), which are similar to the data on production of these cytokines in response to stimulation with TLR ligands. As shown herein, the serum cytokine profiles are prone to high variability, likely related to the complex matrix of the serum samples, including the potential for non-specific binding by heterophilic antibodies. In contrast to cytokine profiles of stimulated PBMC, the results provided herein demonstrate that the serum profiles could not discriminate patients with established disease from controls, indicating that the serum levels do not provide information on the status of peripheral immune dysregulation when the disease state is clinically controlled. While the use of patient sera has the advantages of being readily accessible, easy to store, and less laborious to use as compared to cell-culture based approaches, profiling cytokine responses of peripheral immune subsets appears to have the advantage of lower variability and better discrimination of patient groups.

It was questioned whether or not differences in the frequency of peripheral blood cell types in the PBMC samples could account for the variability in the cytokine response profiles observed between the groups. The patients with early RA had marginally higher total leukocytes and lymphocytes yet had lower T cell cytokine responses as compared to the patients with established RA. Further, the patients with early disease had marginally lower IL-17 and GM-CSF responses to HSP60 stimulation yet had higher lymphocyte and monocyte counts. The differences in the distributions of total leukocytes and basophils that were statistically significant were not clinically meaningful, and the values for both patient groups were within the laboratory reference ranges. These data clearly demonstrate that differences in routine blood leukocyte differentials do not account for the results provided herein. An important conclusion from the results provided herein is that cytokine response profiling offers information that is not available from routine clinical laboratory techniques.

Ex vivo cytokine response profiles of PBMC discriminated patients with early and established RA from healthy volunteers. Impaired responsiveness of peripheral Th1/Th2 cells and increased responsiveness of Th17 and myeloid subsets characterized early RA. In contrast, among the patients with established RA, these Th1/Th2 abnormalities appeared to be partially attenuated whereas Th17 and myeloid responses appeared to be increased to a greater degree than the patients with early disease. The methods and materials provided herein can be used to assess immunologic recovery versus persisting deleterious immune dysfunction, which can predict adverse outcomes for patients with RA.

### Example 2

### Altered Responsiveness of Peripheral Cell-Mediated Immunity, but not Humoral Immunity, is Associated with Myocardial Dysfunction in Rheumatoid Arthritis

The following was performed to identify biomarkers of left ventricular diastolic dysfunction (LVDD) in persons with RA by investigating immune response signatures to a specific panel of stimuli among RA patients with and without LVDD. Such signatures can be used to identify patients at risk of LVDD as well as to discover mechanisms of pathogenesis.

Adult patients with RA (1987 ACR criteria) and no history of heart failure (HF) were recruited from a community-based cohort. All patients underwent 2D/Doppler echocardiography according to a standardized protocol. LVDD was defined as impaired relaxation or advanced reduction in compliance or restrictive filling. Peripheral blood mononuclear cells were harvested from the patients and stimulated with the following: CD3/CD28; cytomegalovirus/Epstein-Barr virus lysates (CMV/EBV); CpG-nucleotides (CPG); heat shock protein 60 (HSP60); phytohemaglutinin (PHA); phorbol myristyl acetate/ionomycin (PMA/ION); staphylococcal enterotoxins A & B (SEA/B); or none.

Cytokines secreted in response to the stimuli were analyzed using a multiplex assay with a 17-cytokine panel. The associations between normalized cytokine values and LVDD were determined using generalized linear models adjusted for patient and cytokine plate.

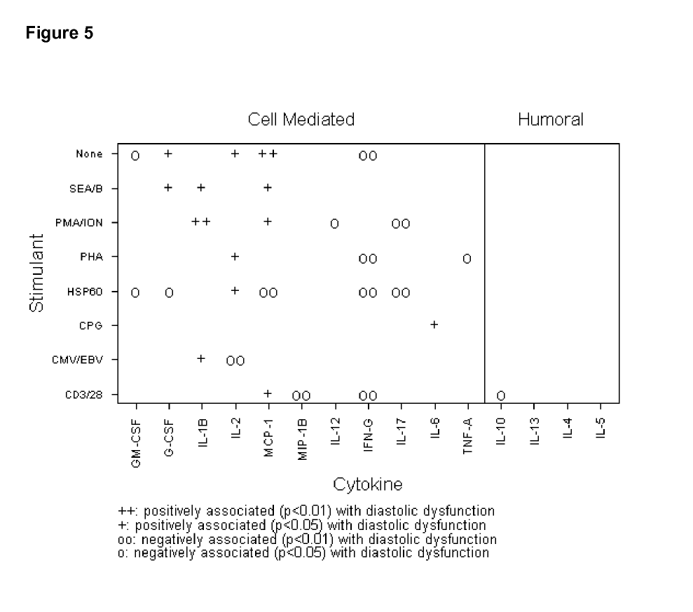

Seventy-three RA patients (mean age 64.6±11.8 years; 77% female) with mean disease duration 14.1 years were recruited. LVDD was present in 33 subjects (45%): 17 mild; 16 moderate/severe; and 16 indeterminate. FIG. 5 shows the associations between stimulant-specific cytokine secretion and LVDD. Among cytokines involved in cell-mediated immunity (e.g., GM-CSF, G-CSF, IL-10, IL-2, MCP-1, MIP-1β, IL-12, IFN-γ, IL-17, IL-6, and TNF-α), a statistically significant pattern of altered responsiveness was found to be associated with LVDD where some cytokines showed significantly increased responsiveness and others significantly decreased responsiveness (FIG. 5). No cytokines involved in humoral immunity (e.g., IL-4, IL-5, IL-10, and IL-13) were associated with LVDD.

Among RA patients without HF, altered responsiveness of cytokines involved in cell-mediated immunity, but not humoral immunity, was significantly associated with LVDD. These results demonstrate that immune mechanisms are important to the pathogenesis of myocardial dysfunction and that a blood-based immune signature can be used to identify RA patients prone to LVDD and ultimately HF.

### Example 3

### Cytokine Response Profiling Identifies an Immunologic Signature of Myocardial Dysfunction in Rheumatoid Arthritis

People with RA have an increased risk of heart failure (HF), which may be partially mediated by inflammatory mechanisms. The following was performed to identify immunologic signatures that can be used to identify patients at risk for left ventricular diastolic dysfunction (LVDD), a pre-clinical stage of HF, and to develop hypotheses about pathogenesis.

A population-based sample of subjects with RA (1987 ACR criteria) was studied. Data on clinical characteristics (i.e., RA features, cardiovascular risk factors) were collected. LVDD was rigorously assessed by 2D/Doppler echocardiography using a validated algorithm and categorized as none, mild, or moderate-severe LVDD. Fresh PBMC from subjects were stimulated ex vivo under eight conditions, including: anti-CD3/anti-CD28 (CD3/CD28); phytohemagglutinin (PHA); bacterial CpG oligonucleotides (CPG); or human heat shock protein 60 (HSP60). The profiles of cytokine release were analyzed using 17-plex immunoassays. Differences in the stimulated cytokine values between the 3 categories of LVDD were tested using mixed effects models, adjusting for assay effects and clinical characteristics.

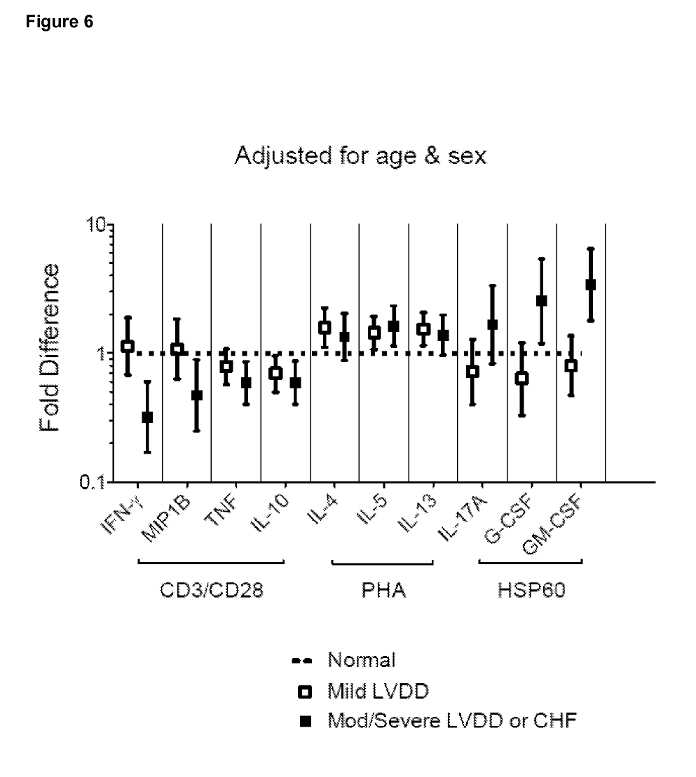

The study included 267 subjects (mean age: 60.8±13.9 yrs; disease duration: 9.6±6.6 yrs) with low disease activity (mean CRP: 2.7±4.9 mg/L). Of these, 134 subjects (50%) had normal left ventricular function, 53 (20%) had mild LVDD, 25 (9%) had moderate/severe LVDD or HF; 55 (21%) with indeterminate data were excluded. A 13-cytokine signature was developed that discriminated patients with moderate-severe LVDD or HF from the remainder. The signature included decreased responsiveness to CD3/CD28 of Th1 (e.g., IFN-γ, MIP1β, and TNF-α) and Th2 (e.g., IL-10) subsets; increased responsiveness to PHA of Th2 (e.g., IL-4, IL-5, and IL-13); decreased responsiveness to CPG (e.g., IL-7 and IL-8); and increased responsiveness to HSP60 of Th17 or myeloid subsets (e.g., IL-17A, G-CSF, and GM-CSF) (FIG. 6). These associations remained significant after adjusting for age, sex, cardiovascular risk factors, known coronary heart disease, rheumatoid factor, anti-CCP, HAQ disability index, and CRP.

In patients with RA, a 13-cytokine signature determined by ex vivo cytokine response profiling of PBMC discriminated patients with moderate/severe LVDD or HF. These results demonstrate that a blood-based immunologic signature can be used to identify patients at risk for adverse disease outcomes such as heart failure. Further, the regulation of the Th17/IL-17 pathway may play an important role in the pathogenesis of myocardial dysfunction in patients with RA.

### Example 4

### Cytokine Response Profiling Identifies Immunologic Signatures of Poor Health Related Quality of Life in Rheumatoid Arthritis

A significant problem in caring for patients with RA is how to determine whether pain, fatigue, or impaired health-related quality of life (HRQOL) are due to the disease or other factors. The following was performed to determine immunologic signatures of the various domains of HRQOL in patients with RA that could be valuable in evaluating response to therapy.

Patients with early inflammatory arthritis or RA (1987 ACR criteria) seropositive for rheumatoid factor and/or anti-citrullinated proteins were included. Data on HRQOL were collected, including the Health Assessment Questionnaire (HAQ) disability index and the Medical Outcomes Study short form 36 (SF-36). The HRQOL outcomes were dichotomized according to published thresholds for patient-defined “acceptable symptom states.” Fresh peripheral blood mononuclear cells (PBMC) from patients were stimulated ex vivo under eight conditions, including: anti-CD3/anti-CD28 (CD3/CD28); phytohemagglutinin (PHA); bacterial CpG nucleotides (CPG); and human heat shock protein 60 (HSP60). The profiles of cytokine release into culture supernatants were analyzed using multiplex immunoassays with a 17-cytokine panel. Mixed effects models were used to analyze the fold changes in cytokine values between poor vs. good HRQOL groups, adjusting for age, sex, and assay effects.

The study included 57 patients (mean disease duration 9.4±10.1 months), of whom 51 (89%) fulfilled RA criteria. The group had moderate levels of disease activity (mean DAS28: 4.4±1.2), disability (mean HAQ: 0.8±0.8), and pain (mean VAS: 41.9±28.3). Analyses revealed a 12-cytokine profile that discriminated the groups. A signature was identified for high bodily pain (SF-36 bodily pain <35) and high disability (HAQ>1) that was characterized by increased responses to PHA (e.g., IFN-γ, IL-4, IL-5, and IL-13) but decreased responses to CPG (e.g., IL-1β and IL-6) and HSP60 (e.g., IL-17α, G-CSF, and GM-CSF). Poor general health (SF-36 global health <47) was discriminated by reduced HSP60 responses (e.g., IL-17A and GM-CSF) but not by PHA or CPG responses. In contrast, poor vitality (SF-36 vitality <40) was correlated with increased responses to anti CD3/CD28 antibodies (e.g., IL-8, IL-10, and TNF-α) and increased HSP60-induced IL-17α.

Cytokine response profiling of PBMC revealed an immunologic signature of pain and disability in patients with early active RA, involving significantly increased responsiveness of Th1 and Th2 subsets to PHA and significantly decreased responsiveness of myeloid lineages to CPG and of Th17 cells to HSP60. These results demonstrate that cytokine response profiling can be used to discriminate disease-associated impairments of HRQOL and monitor response to therapy.

### Example 5

### Immune Monitoring in Patients with Rheumatoid Arthritis: Correlating the Responsiveness of Ex Vivo Cytokine Production with Clinical Disease Activity

### Materials and Methods

### Study Design and Participants

A cross-sectional correlative study was conducted in the setting of the outpatient practice of the Division of Rheumatology at Mayo Clinic Rochester. A convenience sample of patients referred by the 16 physicians in the Division was recruited. The majority of the patients resided within 100 miles of the clinic. Adult patients of >18 years of age with a physician diagnosis of undifferentiated inflammatory arthritis or rheumatoid arthritis were eligible to participate if they met the following two criteria: 1) Either fulfillment of the American College of Rheumatology (ACR; formerly the American Rheumatism Association) 1987 criteria for the classification of RA (Arnett et al., Arthritis Rheum., 31(3):315-324 (1988)), or achievement at the baseline visit of a Leiden early RA prediction score of ≧8, indicating 90% probability or greater of progressing to overt RA as defined by the ACR criteria at one year (van der Helm-van Mil et al., Arthritis Rheum., 58(8):2241-2247 (2008) and van der Helm-van Mil et al., Arthritis Rheum., 56(2):433-440 (2007)); and 2.) Seropositive status for rheumatoid factor (RF), anti-citrullinated protein antibodies (ACPA), or both. Prednisone use was permitted. Some of the patients who were seen at the time of diagnosis were also evaluated longitudinally at 4 weeks, 12 weeks, 24 weeks, or all three time-points. The Mayo Foundation institutional review board approved this study, which was conducted according to the principles of the Declaration of Helsinki. All patients provided written informed consent.

### Data Collection

One consultant rheumatologist evaluated tender and swollen joints using modified 28-joint counts (Prevoo et al., Arthritis Rheum., 38:44-48 (1995)) and the physician global assessment of disease activity using a 0-100 mm visual analogue scale (VAS). The patient reported outcomes (PROs) included the levels of pain and fatigue (0-100 mm VASs), the duration of morning stiffness (minutes), the Short Form McGill Pain Questionnaire (SF-MPQ) (Melzack, Pain, 1(3):277-299 (1975) and Melzack, Pain, 30(2):191-197 (1987)), the Stanford Health Assessment Questionnaire (HAQ) disability index (Fries et al., Arthritis Rheum., 23(2):137-145 (1980) and Fries et al., J. Rheumatol., 9(5):789-793 (1982)), and the Medical Outcomes Study Short-Form 36 (SF-36) (McHarney et al., Med. Care, 32(1):40-66 (1994) and McHomey et al., Med. Care, 31(3):247-263 (1993)). Disease activity was defined by the patient and physician global assessments of disease activity (PGA and MDGA, respectively, using 100-mm VASs), the Disease Activity Score in 28 joints using the C-reactive protein (DAS28) (Prevoo et al., Arthritis Rheum., 38:44-48 (1995)), the simplified disease activity index (SDAI) (Smolen et al., Rheumatology (Oxford), 42(2):244-257 (2003)), and the clinical disease activity index (CDAI) (Aletaha and Smolen, Clin. Exp. Rheumatol., 23(5 Suppl 39):S100-108 (2005)). Data were collected on patient demographics, disease duration, status for rheumatoid factor (RF) and anti-citrullinated protein antibodies (ACPA), and the current use of disease-modifying antirheumatic drugs (DMARDs), including biologics. C-reactive protein (CRP) was measured by turbidometric assay (Roche, Indianapolis, Ind.).

### Immune Monitoring

The approach to quantify the broad responsiveness of ex vivo cytokine production was described herein. Functional peripheral blood mononuclear cells (PBMCs) were procured by Ficoll density gradient centrifugation. Within 1-2 hours, 4×10⁵ PBMCs were cultured in 200 μL of medium (RPMI-1640+10% fetal bovine serum+1× penicillin, streptomycin, and glutamine) in the presence of one of a panel of seven stimuli or in medium alone in a 96-well culture plate. The stimulation panel included immobilized anti-CD3 and anti-CD28 monoclonal antibodies (anti-CD3/anti-CD28; Dynabeads Human T-Activator, Invitrogen, Carlsbad, Calif.); bacterial CpG oligonucleotides (CpG); combined CMV and EBV lysates (CMV/EBV; Advanced Biotechnologies, Columbia, Md.); human heat shock protein 60 (HSP60; Stressgen, Victoria BC, Canada); PMA with ionomycin (PMA/ionomycin; Sigma, St. Louis, Mo.); phytohemagglutinin (PHA; Sigma, St. Louis, Mo.); and staphylococcus enterotoxins A and B (SEA and SEB; Toxin Technology, Sarasota, Fla.). The final concentrations of each stimulant were as follows: 1) anti-CD3/anti-CD28, 0.5×10⁶ beads per culture well (1:1 ratio of beads to PBMCs per manufacturer instructions); 2) PHA, 5 μg/mL; 3) staphylococcus enterotoxin A, 10 ng/mL, with staphylococcus enterotoxin B, 10 ng/mL; 4) CMV, 1 μg/mL, with EBV, 1 μg/mL; 5) CpG, 10 μg/mL; 6) HSP60, 1 μg/mL; and 7) PMA, 1 μg/mL, with ionomycin, 700 ng/mL. The PBMCs were incubated at 37° C. in 5% CO₂ for 48 h; the supernatants were then harvested, transferred to a storage plate, and frozen at −80° C. for subsequent analysis.

Multiplexed cytokine analysis was performed to measure cytokine release from the PBMCs into the culture supernatants in response to stimulation using the MSD® 96-Well MULTI-SPOT® Human Cytokine Assays tissue culture kit (Meso Scale Discovery [MSD], Gaithersburg, Md.). The cytokine panel included IL-10, IL-2, IL-4, IL-5, IL-6, IL-7, IL-8 (CXCL8), IL-10, IL-12, IL-13, IL-17, IFNγ, TNFα, MCP-1 (CCL2), MIP1β (CCL4), G-CSF, and GM-CSF. Using the Sector 2400 instrument (MSD) and manufacturer-supplied reagents, the cytokine concentrations were determined based on a standard curve generated for each plate. The results were analyzed using the Discovery Workbench Software v2.0 (MSD).

### Statistical Analysis

The patient characteristics at baseline and follow-up were summarized as median (25^{th}, 75^{th} percentile) or number (%). In the first phase of the analysis, factor analysis was used to combine individual PROs, including the pain level by VAS, morning stiffness, the HAQ disability index, the SF-MPQ sensory and affective scores, and the SF-36 subscales, into a single composite PRO. The loadings for the first factors were used to weight each PRO in the composite PRO, which was the dependent variable in subsequent analytic steps.

Two approaches were used to analyze the cytokine profiles and derive a multi-cytokine disease activity signature. For normalization of the cytokine data, mixed effects models were used as described herein. The mixed models were used to estimate the differences in cytokine release between patients with high relative to low disease activity as defined by the composite PRO variable, which was dichotomized at the median for this purpose. The differences were tested using the 1 degree of freedom (df) test. The data were reported for stimulant-cytokine combinations that were different between the groups at the statistical significance level of 0.1, which was chosen for descriptive purposes. The other approach was to use model-averaging methods, which have the capacity to assimilate the highly inter-connected and interdependent information. Gradient boosting tree models (GBM) were used to summarize the 136 cytokine concentrations (17 cytokines×8 conditions) into a complex immunologic prediction score. The output of this model enables the ordering of the cytokines and stimulation conditions according to their relative importance (R²).

The correlation of the prediction score with the PROs and disease activity measures was determined using Spearman coefficients. Multivariate linear regression models were used to determine the association of the multi-cytokine prediction score with the DAS28 independent of clinical covariates.

### Results

### Baseline and Follow-Up Characteristics

A total of 98 patients were evaluated at 136 total study time-points. The median disease duration was 5.1 months. Eighty-one percent of the patients fulfilled the ACR criteria for RA, and the remaindered were classified using the Leiden early RA prediction rule. The majority of patients, 81%, were seropositive for ACPA.

Some of the patients with recently diagnosed RA were seen for follow-up at 4, 12, and/or 24 weeks. Overall, the disease activity was moderate at these study visits with a median DAS28 of 4.5 (3.6, 5.4). At the time of the patient visits, patients were receiving methotrexate (63%), hydroxychloroquine (36%), or both. Prednisone was used by patients at 66 (49%) of the visits.

### Derivation of the Composite Patient-Reported Outcome

Factor analysis was used to derive a composite PRO, which was used as a single continuous variable to characterize disease activity for subsequent analytic steps. The rationale for this approach was based on preliminary observations that profiles of multi-cytokine release from PBMC were more strongly correlated with individual PROs then with the individual components of the DAS28. The composite PRO would enable the identification of a unifying signature of aberrant immune function correlated with RA disease activity rather than having to combine profiles from each separate PRO. Instruments were selected to represent key domains of clinical disease activity, including pain (100-mm VAS, SF-MPQ, and SF-36 bodily pain subscale); disability (HAQ disability index and SF-36 physical functioning subscale); fatigue (100-mm VAS and SF-36 vitality); morning stiffness (duration in minutes); and health-related quality of life (other SF-36 subscales).

The factor analysis resulted in the creation of a composite PRO for use in subsequent analytic steps. Pain, assessed by the top four factors in the model, had the strongest influence on the composite PRO representing clinical disease activity in this analysis (Table 4). Fatigue, assessed by the bottom three factors in the model (100-mm VAS, SF-36 general health subscale and SF-36 vitality subscale), had the lowest influence on the composite PRO in this analysis.

TABLE 4
Results of the factor analysis, showing the distributions
for the individual patient-reported outcomes and
the factor loadings for each in the model

| Factors | Median (25th, 75th percentiles) | | Loadings |
|---|---|---|---|
| SF-MPQ sensory (0-33) | 9.0 | (3.0, 14.0) | 0.77 |
| Pain VAS (0-100 mm) | 44 | (20, 69) | 0.72 |
| SF-MPQ affective (0-12) | 1.0 | (0.0, 5.0) | 0.64 |
| SF-36 Pain Index | 41 | (31, 62) | 0.58 |
| HAQ Disability index (0-3) | 0.6 | (0.1, 1.4) | 0.48 |
| SF-36 Social Functioning | 75 | (50, 100) | 0.37 |
| SF-36 Mental Functioning | 76 | (60, 88) | 0.36 |
| Morning stiffness (minutes) | 45 | (15, 90) | 0.29 |
| SF-36 Physical Functioning | 50 | (30, 80) | 0.29 |
| Fatigue VAS (0-100 mm) | 48 | (23, 69) | 0.28 |
| SF-36 Gen. Health | 62 | (40, 77) | 0.22 |
| SF-36 Vitality | 46 | (25, 65) | 0.16 |

SF-MPQ = short form McGill Pain Questionnaire; VAS = visual analogue scale; SF-36 = Medical Outcomes Study Short Form 36; HAQ = Health Assessment Questionnaire.

Profiles of Ex Vivo Cytokine Production Correlate with the Composite PRO

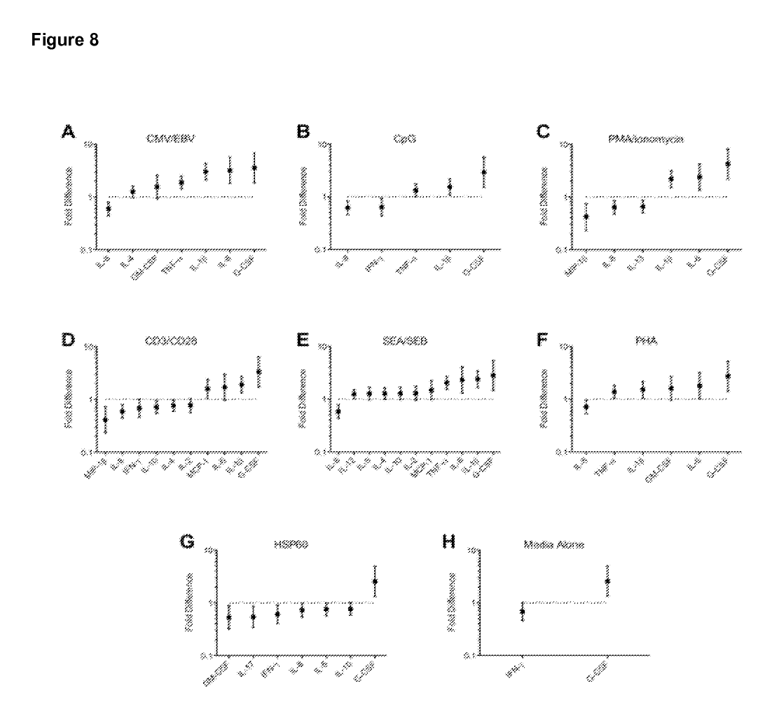

The next step was to describe the direction and magnitude of differences between patients with high relative to low clinical disease activity as defined by the composite PRO. For this analysis, the fold differences in the geometric mean cytokine concentrations for patients with high were compared relative to low composite PRO values at p<0.1 (FIG. 8). The direction of typically T cell-derived cytokines was dependent on the stimulation. For example, decreased release of the following cytokines was observed under various stimulations in patients with high relative to low composite PRO values: IFN-γ, IL-2, IL-4, and IL-10 with anti-CD3/CD28 (FIG. 8A); MIP-1β and IL-13 with PMA/ionomycin (FIG. 8C); IFN-γ with CpG (FIG. 8E); IL-17, IFN-γ, IL-5, and IL-10 with HSP60 (FIG. 8G); and IFN-γ in medial alone (FIG. 8H). In contrast, increased release of the following cytokines was observed under various stimulation conditions: IL-4 with CMV/EBV (FIG. 8D); IL-2, -4, -5, -10, with SEA/SEB (FIG. 8F).

In contrast, the production of typically myeloid cell-derived cytokines was generally increased in the patients with high relative to low composite PRO values. For example, the release of IL-1B was increased in response to stimulation with anti-CD3/anti-CD28 (FIG. 8A), PHA (FIG. 8B), PMA/ionomycin (FIG. 8C), CMV/EBV (FIG. 8D), CpG (FIG. 8E), and SEA/SEB (FIG. 8F). The release of IL-6 was increased in response to stimulation with anti-CD3/CD28 (FIG. 1A), PHA (FIG. 8B), PMA/ionomycin (FIG. 8C), CMV/EBV (FIG. 8D), and SEA/SEB (FIG. 8F). The release of TNF-α was increased in response to stimulation with PHA (FIG. 8B), CMV/EBV (FIG. 8D), CpG (FIG. 8E), and SEA/SEB (FIG. 8F). Overall, there were a far greater number of differences with the stimulated conditions as compared to media alone.

### Development of a Complex Immune Activity Score

Gradient boosting tree analysis was next performed to derive a complex immunologic score for predicting the level of clinical disease activity. In this model, the relative importance (R²) of each stimulation-cytokine combination in the prediction of the composite PRO was analyzed. The top 12 most influential combinations were: MIP-1β with CMV/EBV (R²=7.2%), IFN-γ with CpG (R²=3.8%), MIP-1β with anti-CD3/anti-CD28 (R²=3.8%), IL-5 with HSP60 (R²=3.5%), G-CSF with SEA/SEB (R²=2.6%), IL-7 with PHA (R²=2.5%), IL-13 with PMA/ionomycin (R²=2.5%), IL-7 with CpG (R²=2.4%), IL-10 with anti-CD3/anti-CD28 (R²=2.0%), IL-4 with PMA/ionomycin (R²=1.9%), G-CSF with PMA/ionomycin (R²=1.9%), and IL-13 with CMV/EBV (R²=1.9%).

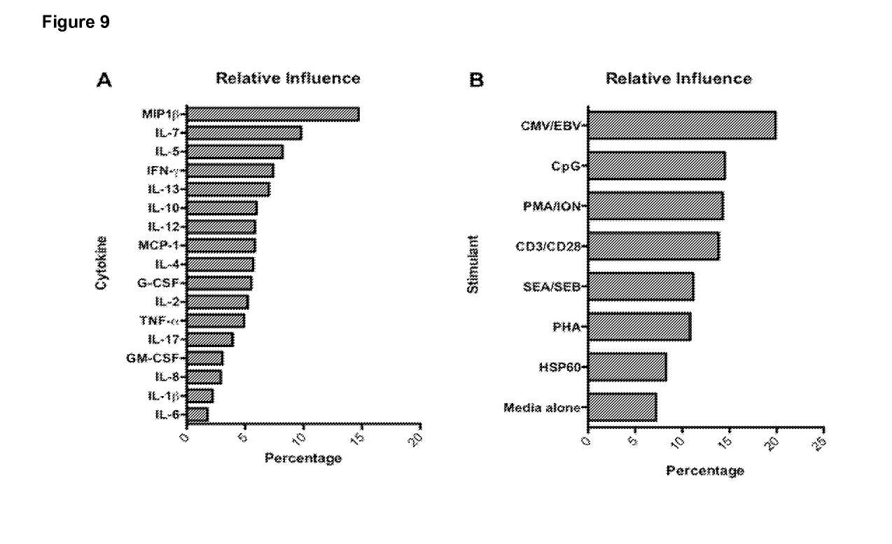

The relative influence was analyzed by cytokine and by stimulation (FIG. 9). Cytokines involved in regulating or effecting T cell responses demonstrated the highest relative influence in the model. Overall, MIP-1β, IL-7, IL-5, IFN-γ, and IL-13 had the biggest sway in predicting current disease activity based on the composite PRO. Interestingly, TNF-α, IL-17, GM-CSF, IL-1β, and IL-6 each accounted for <5% of the predictive capacity of the model. Regarding the stimulations, CMV/EBV stimulation had the highest relative influence, followed by CpG, PMA/ionomycin, and anti-CD3/anti-CD28. The measurement of cytokines in media along without additional stimulation was the least informative of the conditions in predicting the level of clinical disease activity.

### Validity of the Score to Predict the Level of Clinical Disease Activity

In order to demonstrate that the immune activity score measures clinical disease activity as intended, the correlation of the score with the individual PROs used in training as well as with validated clinical disease activity indexes was assessed (Table 5). Age and sex did not confound the relationship of the score with clinical disease activity. The immune activity score correlated moderately well with the PROs used in the factor analysis, supporting evidence of construct validity. In other words, the score is related to other theoretical constructs, including pain, disability, morning stiffness, and quality of life, that are known to reflect underlying disease activity. Statistically significant correlations of the score were observed with the ACR core set measures, including the tender and swollen joint counts, patient and physician global assessments, and the C-reactive protein, and also with validated disease activity measures, including the DAS28, CDAI, and SDAI. However, the complex immune activity score derived here was not correlated with radiographic erosions or joint space narrowing.

TABLE 5
Correlations of the multi-cytokine prediction score with
the patient-reported outcomes used to train the score and
with validated clinical disease activity indexes.

| Variable | Coefficient | 95% CI | P |
|---|---|---|---|
| Age, years | 0.004 | | 0.96 |
| Sex | 0.07 | | 0.42 |
| Pain, 0-100 mm* | 0.52 | | <0.001 |
| Morning stiffness* | 0.43 | | <0.001 |
| SF-36*† | | | |
| Physical functioning | −0.51 | | <0.001 |
| Bodily pain | −0.48 | | <0.001 |
| General health | −0.39 | | <0.001 |
| Vitality | −0.34 | | <0.001 |
| Social functioning | −0.48 | | <0.001 |
| Mental health | −0.33 | | <0.001 |
| HAQ score* | 0.51 | | <0.001 |
| Tender joint count 68 | 0.28 | | 0.001 |
| Swollen joint count 66 | 0.29 | | <0.001 |
| Patient global | 0.46 | | <0.001 |
| Physician global | 0.34 | | <0.001 |
| C-reactive protein | 0.39 | | <0.001 |
| DAS28 | 0.46 | | <0.001 |
| CDAI | 0.39 | | <0.001 |
| SDAI | 0.41 | | <0.001 |
| Erosions | 0.01 | | 0.96 |
| Joint space narrowing | 0.17 | | 0.25 |

*Variables used to derive the composite patient-reported outcome, which was used to train the multi-cytokine prediction score.
†The negative correlations for the SF-36 are due to the scales, 0-100, with lower values indicating poorer health status.

Association of the Complex Immune Activity Score with the DAS28

A multivariate linear regression analysis was performed to assess for an independent association of the immune activity score with the DAS28 after adjusting for clinical covariates (Table 6). The immune activity score (per 10 units, range 0-100) was associated with the DAS28 with a β coefficient of 0.249 (standard error: 0.063; p=0.0002) after adjusting for age, sex, morning stiffness, methotrexate use, other DMARD use, use of biologic agents, and prednisone use. Morning stiffness and methotrexate use were also significant predictors of the concurrent DAS28 value in this study.

TABLE 6
Multivariate analysis demonstrates and independent association
of the multi-cytokine prediction score with the DAS28 after
adjusting for clinical covariates and RA medications.

| Variable | β | Standard Error | P |
|---|---|---|---|
| Intercept | 3.670 | 0.610 | <0.0001 |
| Age | −0.005 | 0.009 | 0.5644 |
| Male | −0.044 | 0.243 | 0.856 |
| Morning stiffness | 0.003 | 0.001 | 0.016 |
| Methotrexate | −0.548 | 0.246 | 0.028 |
| Other DMARDs | −0.157 | 0.251 | 0.533 |
| Biologic agents | −0.069 | 0.437 | 0.875 |
| Prednisone | 0.264 | 0.235 | 0.265 |
| Multi-cytokine score | 0.249 | 0.063 | 0.0002 |
| (per 10 units) | | | |

Results from a multivariate linear regression model. DAS28 = disease activity score in 28 joints; RA = rheumatoid arthritis; DMARDs = disease-modifying antirheumatic drugs.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for assessing the severity of rheumatoid arthritis in a mammal, wherein said method comprises:
(a) contacting a first sample of cells from said mammal with a first stimulant to obtain a treated first sample,
(b) contacting a second sample of cells from said mammal with a second stimulant to obtain a treated second sample,
(c) contacting a third sample of cells from said mammal with a third stimulant to obtain a treated third sample,
(d) determining the amount of at least two different cytokine polypeptides present in said treated first sample, said treated second sample, and said treated third sample to obtain an expression profile, and
(e) diagnosing said mammal as having severe or mild rheumatoid arthritis based on said expression profile.

2. The method of claim 1, wherein said mammal is a human.

3. The method of claim 1, wherein said cells are peripheral blood mononuclear cells.

4. The method of claim 1, wherein said first stimulant, said second stimulant, and said third stimulant are selected from the group consisting of anti-CD3/anti-CD28 antibodies, CMV/EBV, HSP60, PHA, SEA/SEB, CpG, and PMA.

5. The method of claim 1, wherein said first stimulant is a stimulant to elicit T cell responses.

6. The method of claim 1, wherein said second stimulant is a stimulant to elicit adaptive and innate cytokine responses.

7. The method of claim 1, wherein said third stimulant is a stimulant to elicit innate cytokine responses.

8. The method of claim 1, wherein said at least two different cytokine polypeptides are selected from the group consisting of IL-1β, IL-2, IL-4, IL-5, IL-6, IL-7, IL-8 (CXCL8), IL-10, IL-12, IL-13, IL-17, IFNγ, TNF-α, MCP-1, MIP1β, G-CSF, and GM-CSF polypeptides.

9. A method for determining whether or not a mammal having rheumatoid arthritis has an increased risk for developing myocardial dysfunction, wherein said method comprises:
(a) contacting a first sample of cells from said mammal with a first stimulant to obtain a treated first sample,
(b) contacting a second sample of cells from said mammal with a second stimulant to obtain a treated second sample,
(c) contacting a third sample of cells from said mammal with a third stimulant to obtain a treated third sample,
(d) determining the amount of at least three different cytokine polypeptides present in said treated first sample, said treated second sample, and said treated third sample to obtain an expression profile, and
(e) diagnosing said mammal as having an increased risk for developing myocardial dysfunction or as not having an increased risk for developing myocardial dysfunction based on said expression profile.

10. The method of claim 1, wherein said mammal is a human.

11. The method of claim 1, wherein said cells are peripheral blood mononuclear cells.

12. The method of claim 1, wherein said first stimulant, said second stimulant, and said third stimulant are selected from the group consisting of anti-CD3/anti-CD28 antibodies, CMV/EBV, HSP60, PHA, SEA/SEB, CpG, and PMA.

13. The method of claim 1, wherein said first stimulant is a stimulant to elicit T cell responses.

14. The method of claim 1, wherein said second stimulant is a stimulant to elicit adaptive and innate cytokine responses.

15. The method of claim 1, wherein said third stimulant is a stimulant to elicit innate cytokine responses.

16. The method of claim 1, wherein said at least three different cytokine polypeptides are selected from the group consisting of IL-10, IL-2, IL-4, IL-5, IL-6, IL-7, IL-8 (CXCL8), IL-10, IL-12, IL-13, IL-17, IFNγ, TNF-α, MCP-1, MIP113, G-CSF, and GM-CSF polypeptides.

17. The method of claim 1, wherein said myocardial dysfunction is heart failure.

18. The method of claim 1, wherein said myocardial dysfunction is left ventricular diastolic dysfunction.

19. A method for assessing the severity of rheumatoid arthritis in a mammal, wherein said method comprises:
(a) contacting a first sample of cells from said mammal with a first stimulant to obtain a treated first sample,
(b) contacting a second sample of cells from said mammal with a second stimulant to obtain a treated second sample,
(c) contacting a third sample of cells from said mammal with a third stimulant to obtain a treated third sample,
(d) determining the amount of a first cytokine polypeptide present in said treated first sample relative to an untreated sample of cells from said mammal to obtain a first expression profile,
(e) determining the amount of a second cytokine polypeptide present in said treated second sample relative to an untreated sample of cells from said mammal to obtain a second expression profile,
(f) determining the amount of a third cytokine polypeptide present in said treated third sample relative to an untreated sample of cells from said mammal to obtain a third expression profile, and
(g) diagnosing said mammal as having severe or mild rheumatoid arthritis based on one or more of said first, second, or third expression profiles.

20. The method of claim 19, wherein said first, second, and third stimulants are different.

21-34. (canceled)
